(19) United States
(12) Patent Application Publication
(10) Pub. No.: US 2026/0151726 A1
(43) Pub. Date: Jun. 4, 2026

(54) CARBON DIOXIDE CAPTURE SYSTEM WITH pH CONTROL FUNCTION

(71) Applicants: HYUNDAI MOTOR COMPANY, Seoul (KR); KIA CORPORATION, Seoul (KR)

(72) Inventors: Se Won Pyo, Hwaseong-si (KR); Ji Hoon Jang, Hwaseong-si (KR); Yun Su Lee, Hwaseong-si (KR)

(73) Assignees: HYUNDAI MOTOR COMPANY, Seoul (KR); KIA CORPORATION, Seoul (KR)

(21) Appl. No.: 19/258,075

(22) Filed: Jul. 2, 2025

(30) Foreign Application Priority Data
Nov. 11, 2024 (KR) 10-2024-0158787

(51) Int. Cl. B01D 53/14; B01D 53/18; B01D 53/62; B01D 53/96

(52) U.S. Cl. CPC B01D 53/1475; B01D 53/1425; B01D 53/1493; B01D 53/185; B01D 53/62; B01D 53/965; B01D 2251/604; B01D 2252/10; B01D 2257/504

(57) ABSTRACT

A carbon dioxide capture system with a pH control function, allowing for the recirculation of an electrolyte solution.

### CROSS REFERENCE TO RELATED APPLICATION

The present application claims priority to Korean Patent Application No. 10-2024-0158787, filed Nov. 11, 2024, the entire contents of which is incorporated herein for all purposes by this reference.

### FIELD

The present disclosure relates to a carbon dioxide capture system with a pH control function, enabling recirculation of an electrolyte solution.

### BACKGROUND

Recently, research on electrochemical water electrolysis has been actively underway in line with renewable energy development to respond to climate change. Additionally, carbon dioxide (CO₂) capture, storage, and conversion techniques to reduce greenhouse gases have become important.

Representative carbon dioxide capture techniques include methods based on amine compounds, methods using solid absorbents, and methods using membrane contactors.

The carbon dioxide capture method based on amine compounds requires a lot of energy to regenerate the amine compounds and affects the durability of the equipment due to its highly corrosive properties.

The method using solid absorbents for capturing carbon dioxide requires periodic replacement due to performance deterioration of absorbents and has a slow absorption rate of carbon dioxide.

Methods using membrane contactors for capturing carbon dioxide utilize differences in solubility depending on the gas type. Specifically, the method brings a gas mixture containing carbon dioxide into contact with an aqueous solution to dissolve and separate carbon dioxide included in the gas mixture into the aqueous solution. The method using membrane contactors for capturing carbon dioxide has the advantage of high collection efficiency since a reaction between the aqueous solution and the carbon dioxide is fast, and offers relatively low cost and low energy requirements. Typically, when water is applied to the aqueous solution, carbon dioxide removal efficiency is shown to be at about 85%. Similarly, when propylene carbonate is added to the water, typical carbon dioxide removal efficiency is shown to be at about 91%. Nevertheless, regardless of the current state of the art, new techniques offering higher removal rates are needed in order to move closer toward, or to achieve, carbon neutrality.

### SUMMARY OF THE DISCLOSURE

In one aspect the present disclosure provides a system with very high carbon dioxide capture efficiency.

In another aspect, the present disclosure provides a system capable of continuously capturing carbon dioxide.

In a further aspect, the present disclosure provides a system capable of selectively collecting carbon dioxide included in a gas mixture.

In yet a further aspect, the present disclosure provides a system that is easy to scale up.

The various aspects of the present disclosure is not limited to those mentioned above. Other aspects and embodiments of the present disclosure will become clearer from the following description and may be realized by means and combinations thereof as set forth in the claims.

According to an embodiment of the present disclosure, the carbon dioxide capture system may include: an electrolyte storage unit for storing a first electrolyte solution containing an aqueous alkaline carbonate solution; an intake unit for preparing a concentrated liquid by dissolving carbon dioxide included in a gas mixture into the first electrolyte solution supplied from the electrolyte storage unit; a degassing unit for degassing carbon dioxide from the concentrated liquid supplied from the intake unit and discharging the carbon dioxide; a distribution unit for receiving a discharge liquid discharged from the degassing unit and distributing the discharge liquid; a first reaction unit for preparing a carbonate and an aqueous alkaline solution by receiving a portion of the discharge liquid from the distribution unit and reacting the portion of the discharge liquid with hydroxide; and a second reaction unit for preparing a second electrolyte solution and supplying the second electrolyte solution into the electrolyte storage unit, the preparation being done by receiving the remaining portion of the discharge liquid from the distribution unit and an aqueous alkaline solution from the first reaction unit and reacting the remaining portion of the discharge liquid with the aqueous alkaline solution.

In embodiments, the aqueous alkaline carbonate solution may include one or more of an aqueous sodium carbonate (Na₂CO₃) solution, an aqueous potassium carbonate (K₂CO₃) solution, or combinations thereof. In some embodiments, the aqueous alkaline carbonate solution may be selected from the group consisting of an aqueous sodium carbonate (Na₂CO₃) solution, an aqueous potassium carbonate (K₂CO₃) solution, and combinations thereof.

In embodiments, the aqueous alkaline carbonate solution may have a concentration of 0.0001 M to 0.5 M.

In embodiments, the first electrolyte solution may have a pH of 9 to 12.5.

In embodiments, the intake unit may include an intake separation membrane installed therein to divide its space into an electrolyte flow space and a gas mixture flow space. Carbon dioxide included in the gas mixture and flowing in the gas mixture flow space may pass through the intake separation membrane and be dissolved in the first electrolyte solution flowing in the electrolyte flow space.

In embodiments, the gas mixture may include one or more of steelmaking by-product gas, exhaust gas, or combinations thereof. In embodiments, the gas mixture may be selected from the group consisting of steelmaking by-product gas, exhaust gas, and combinations thereof.

In embodiments, the gas mixture flow space may have a pressure of 0.1 bar to 10 bar.

In embodiments, the pressure of the gas mixture flow space is lower than the pressure of the electrolyte flow space. In embodiments, the pressure difference between the gas mixture flow space and the electrolyte flow space may be in a range of 3 bar or less.

In embodiments, the ratio of a flow rate of the gas mixture to a flow rate of the first electrolyte solution supplied to the intake unit (flow rate of the gas mixture/flow rate of the first electrolyte solution) may be in a range of 0.1 to 15.

In embodiments, the concentrated liquid may have a pH of 6 to 9.

In embodiments, the degassing unit may include a degassing separation membrane installed therein to divide its space into a concentrated liquid flow space and a carbon dioxide flow space. Carbon dioxide contained in the concentrated liquid flowing in the concentrated liquid flow space may pass through the degassing separation membrane and be discharged into the carbon dioxide flow space.

In embodiments, the discharge liquid may include one or more selected from the group consisting of an aqueous sodium bicarbonate (NaHCO₃) solution, an aqueous potassium bicarbonate (KHCO₃) solution, and combinations thereof.

In embodiments, the discharge liquid may have a pH of 7 to 9.

In embodiments, the hydroxide may include a hydroxide of calcium (Ca), magnesium (Mg), strontium (Sr), copper (Cu), lithium (Li), barium (Ba), iron (Fe), or combinations thereof. In embodiments, the hydroxide may include a hydroxide of one or more metal ions selected from the group consisting of calcium (Ca), magnesium (Mg), strontium (Sr), copper (Cu), lithium (Li), barium (Ba), iron (Fe), and combinations thereof.

In embodiments, a molar ratio of the portion of the discharge liquid and the hydroxide, which react with each other in the first reaction unit, may be in a range of 1:0.5 to 1:2.

In embodiments, the carbonate may include a carbonate of one or more metal ions of calcium (Ca), magnesium (Mg), strontium (Sr), copper (Cu), lithium (Li), barium (Ba), iron (Fe), or combinations thereof. In embodiments, the carbonate may include a carbonate of one or more metal ions selected from the group consisting of calcium (Ca), magnesium (Mg), strontium (Sr), copper (Cu), lithium (Li), barium (Ba), iron (Fe), and combinations thereof.

The In embodiments, the first reaction unit may further include a filter unit which separates and recovers the carbonate.

In embodiments, the aqueous alkaline solution may include one or more of an aqueous sodium hydroxide (NaOH) solution, an aqueous potassium hydroxide (KOH) solution, or combinations thereof. In embodiments, the aqueous alkaline solution may include one or more selected from the group consisting of an aqueous sodium hydroxide (NaOH) solution, an aqueous potassium hydroxide (KOH) solution, and combinations thereof.

In embodiments, the aqueous alkaline solution may have a pH of 12 to 14.

In embodiments, a molar ratio of the remaining portion of the discharge liquid and the aqueous alkaline solution, which react with each other in the second reaction unit, may be in a range of 1:0.5 to 1:1.2.

In embodiments, the second electrolyte solution discharged from the second reaction unit may have a pH of 9 to 12.5.

According to the present disclosure, a system with very high carbon dioxide capture efficiency can be obtained.

According to the present disclosure, a system capable of continuously capturing carbon dioxide can be obtained.

According to the present disclosure, a system capable of selectively capturing carbon dioxide in a gas mixture can be obtained.

According to the present disclosure, a system that can be easily scaled up can be obtained.

The advantages and effects of the present disclosure are not limited to the advantages and effects mentioned above. That is, the present disclosure should be understood to include all advantages and effects that can be derived and/or inferred from the following description and illustrative examples.

### BRIEF DESCRIPTION OF THE DRAWINGS

FIG. 1 shows a carbon dioxide capture system according to an example embodiment of the present disclosure;

FIG. 2 shows an intake unit according to an example embodiment of the present disclosure;

FIG. 3 shows a degassing unit according to an example embodiment of the present disclosure;

FIG. 4 shows a graph of the results of measuring the concentration of carbon dioxide emitted from the carbon dioxide capture system according an example embodiment of the disclosure as detailed in Example 1; and

FIG. 5 shows a graph of X-ray diffraction analysis of a precipitate obtained in accordance with the example embodiment of the disclosure as detailed in Example 2.

### DETAILED DESCRIPTION

As noted above, aspects, embodiments, objects, other objects, features, and advantages of the present disclosure will be easily understood through the following description of certain embodiments as depicted in the attached drawings. However, the present disclosure is not limited to the example embodiments described herein and may be embodied in other forms. As such, the aspects and example embodiments introduced and detailed herein are provided merely in an effort to provide additional illustration and clarity to the disclosed content in order to more sufficiently convey the spirit of the present disclosure to those skilled in the art.

When describing each drawing, similar reference numerals are used for similar components. In the attached drawings, the dimensions of the structures are enlarged from the actual size for clarity of the present disclosure. Terms such as first, second, etc. may be used to describe various components, but the components should not be limited by the terms. The terms are used only for the purpose of distinguishing one component from another. For example, a first component may be named a second component, and similarly, the second component may also be named a first component without departing from the scope of the present disclosure. Singular expressions include plural expressions unless the context clearly dictates otherwise.

In this specification, terms such as “comprise”, “include”, “contain”, or “have” (and similar terms) are used to specify the presence of features, numbers, steps, actions, components, parts, or combinations thereof as described in the specification, and should not be interpreted as excluding the possibility of the presence or addition of one or more other features, numbers, steps, actions, components, parts, or combinations thereof (i.e., “open” language). These terms are also inclusive of the terms “consisting of” and “consisting essentially of” which are intended to be limited to the specifically recited features, numbers, steps, actions, components, parts, or combinations thereof, and their equivalents. Additionally, when a part of a layer, membrane, region, plate, etc. is said to be “on” another part, this includes not only being “directly above” or overlapping at least some area the other part, but also cases where there is another part in between. Conversely, when a part of a layer, membrane, region, plate, etc. is said to be “underneath” another part, this includes not only being “immediately below” or overlapping at least some area of the other part, but also cases where there is another part in between.

Unless otherwise specified, all numbers, values, and/or expressions used to represent the components, reaction conditions, polymer compositions, and amounts of formulations in this specification are to be understood as approximations, as these values inherently reflect the various uncertainties arising from measurements used to obtain them. Accordingly, in all cases, they should be construed as being qualified by the term “about”. In addition, when numerical ranges are disclosed in this specification, such ranges are continuous and include all values from the minimum value to the maximum value specified, unless otherwise indicated. Furthermore, where the range refers to integers, it includes all integers from the minimum value to the maximum value specified, unless otherwise indicated.

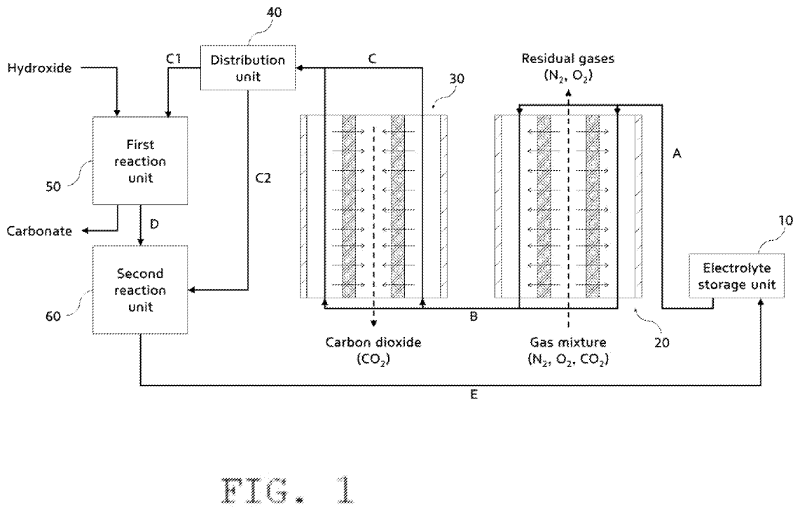

FIG. 1 illustrates a carbon dioxide capture system according to an example embodiments of the present disclosure. Referring to FIG. 1, the carbon dioxide capture system may include: an electrolyte storage unit 10 configured for storing a first electrolyte solution A containing an aqueous alkaline carbonate solution, an intake unit 20 configured for preparing a concentrated liquid B by dissolving carbon dioxide included in a gas mixture into the first electrolyte solution A supplied from the electrolyte storage unit 10, a degassing unit 30 configured for degassing carbon dioxide from the concentrated liquid B supplied from the intake unit 20 and discharging the carbon dioxide, a distribution unit 40 configured for receiving a discharge liquid C discharged from the degassing unit 30 and distributing the discharge liquid C, a first reaction unit 50 configured for preparing a carbonate and an aqueous alkaline solution D by receiving a portion C1 of the discharge liquid from the distribution unit 40 and reacting the portion C1 of the discharge liquid with hydroxide, and a second reaction unit 60 configured for preparing a second electrolyte solution E and supplying the second electrolyte solution E to the electrolyte storage unit 10, the preparation being done by receiving the remaining portion C2 of the discharge liquid from the distribution unit 40 and an aqueous alkaline solution D from the first reaction unit 50 and reacting the remaining portion C2 of the discharge liquid with the aqueous alkaline solution D.

In embodiments, the electrolyte storage unit 10 may include a type of storage tank capable of storing the first electrolyte solution A.

In embodiments, the first electrolyte solution A may include the aqueous alkaline carbonate solution.

The aqueous alkaline carbonate solution, in embodiments, may include one or more selected from an aqueous sodium carbonate (Na₂CO₃) solution, an aqueous potassium carbonate (K₂CO₃) solution, and combinations thereof. In embodiments, the aqueous alkaline carbonate solution preferably may include an aqueous potassium carbonate solution. Herein below, in the description of some non-limiting, illustrative embodiments of the present disclosure, the first electrolyte solution A will be described as containing an aqueous potassium carbonate solution, but the scope of the first electrolyte solution A is not limited thereto.

In embodiments, the aqueous alkaline carbonate solution may have a concentration of about 0.0001 M to 0.5 M. The solubility and selectivity of carbon dioxide included in the gas mixture may be increased by using a low concentration of an aqueous alkaline carbonate solution as the first electrolyte solution A.

In embodiments, the first electrolyte solution A may have a pH of about 9 to 12.5. In embodiments wherein the first electrolyte solution A has a pH within the range, a carbon dioxide absorption rate of the first electrolyte solution A may be maximized.

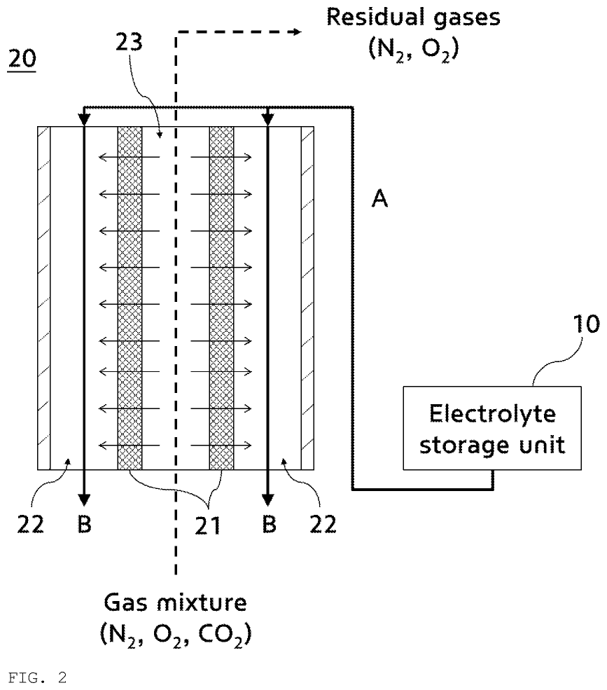

FIG. 2 illustrates an intake unit 20 according to an example embodiment of the present disclosure. Referring to FIG. 2, the intake unit 20 may include an intake separator membrane 21 installed therein. The intake separator membrane 21 may divide an internal space of the intake unit 20 into an electrolyte flow space 22 and a gas mixture flow space 23.

In embodiments, the first electrolyte solution A may be provided into the electrolyte flow space 22. In embodiments, a gas mixture containing carbon dioxide may be supplied from the outside into the gas mixture flow space 23. In embodiments, the first electrolyte solution A and the gas mixture may flow in an opposite direction in a counter-flow arrangement. For example, as illustrated by FIG. 2, when the first electrolyte solution A is supplied to the upper part of the intake unit 20 and discharged to the lower part of the intake unit 20, the gas mixture may be supplied to the lower part of the intake unit 20 and discharged to the upper part of the intake unit 20. This example configuration may be used to increase contact time between the first electrolyte solution A and the gas mixture.

In embodiments, the intake separator membrane 21 may include a hollow fiber made of a polyolefin material such as, for example, polypropylene. Suitably, a surface of the intake separator membrane 21 includes fine pores, such that the gas mixture may pass through the intake separator membrane 21. However, in such embodiments the fine pores do not allow the first electrolyte solution A to diffuse through the intake separator membrane 21.

The area of the intake separation membrane 21 is not particularly limited and may be, for example, in a range of 1 m² to 500 m². In some embodiments, the area refers to the total area of the intake separator membrane 21. In some other embodiments, the area can also refer to a reaction area where the first electrolyte solution A and the gas mixture come into contact through the intake separator membrane 21.

In embodiments, the gas mixture may refer to a gas mixture that comprises carbon dioxide, nitrogen, oxygen, and hydrogen. In some embodiments, the gas mixture may include one or more of steelmaking by-product gas, exhaust gas, and combinations thereof; however, it will be appreciated that the gas mixture is not limited thereto. For example, any gas, such as fossil fuel combustion gas or biomass combustion gas, may be included in the gas mixture as long as the gas contains the above-mentioned components.

In embodiments, the carbon dioxide included in the gas mixture has a high solubility in the first electrolyte solution A at high pressure. In such embodiments, the remaining gases such as nitrogen and oxygen have low solubility in the first electrolyte solution A. In those embodiments, at the interface between the gas mixture and the intake separator membrane 21, the carbon dioxide passes through the intake separator membrane 21 and is dissolved and separated in the first electrolyte solution A, meanwhile, the remaining gases are discharged as residual gases.

In embodiments, the carbon dioxide may be dissolved in the first electrolyte solution A through Reaction Formula 1 below. In Reaction Formula 1, it is assumed that the first electrolyte solution A is an aqueous potassium carbonate solution.

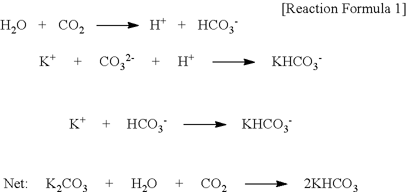

Most of the carbon dioxide included in the gas mixture in the intake unit 20 may be dissolved in the first electrolyte solution A. In some specific embodiments, the content of carbon dioxide included in the residual gases discharged from the intake unit 20 may be in a range of about 0.1% by weight or less.

The carbon dioxide absorption rate of the first electrolyte solution A may be adjusted in various ways.

For example, in one specific embodiment, the pressure of the gas mixture flow space 23 may be lower than the pressure of the electrolyte flow space 22. In embodiments, the pressure of the gas mixture flow space 23 may be in a range of about 0.1 bar to 10 bar. In embodiments, the pressure difference between the gas mixture flow space 23 and the electrolyte flow space 22 may be in a range of about 3 bar or less. Under a pressure difference that exceeds 3 bar, the intake separator membrane 21 may be damaged.

In some additional embodiments, the ratio of a flow rate of the gas mixture to a flow rate of the first electrolyte solution A supplied to the intake unit 20 (flow rate of the gas mixture/flow rate of the first electrolyte solution) may be in a range of about 0.1 to 15. For example, when the content of carbon dioxide included in the gas mixture is in a range of 25% by volume or less, the ratio of the flow rate of the gas mixture to the flow rate of the first electrolyte solution A (flow rate of gas mixture/flow rate of first electrolyte solution) may be in a range of 1 to 10. When the content of carbon dioxide included in the gas mixture is more than 25% by volume and 50% by volume or less, the ratio of the flow rate of the gas mixture to the flow rate of the first electrolyte solution A (flow rate of gas mixture/flow rate of first electrolyte solution) may be in a range of 1 to 15. When the content of carbon dioxide included in the gas mixture is more than 50% by volume and 75% by volume or less, the ratio of the flow rate of the gas mixture to the flow rate of the first electrolyte solution A (flow rate of gas mixture/flow rate of first electrolyte solution) may be in a range of 0.1 to 9. When the content of carbon dioxide included in the gas mixture is more than 75% by volume and 100% by volume or less, the ratio of the flow rate of the gas mixture to the flow rate of the first electrolyte solution A (flow rate of gas mixture/flow rate of first electrolyte solution) may be in a range of 0.1 to 7. When the flow rate ratio falls within the range, the carbon dioxide absorption rate of the first electrolyte solution A may be increased.

In the intake unit 20, carbon dioxide in the first electrolyte solution A may be dissolved to prepare a concentrated liquid B, and supply the concentrated liquid B into the degassing unit 30 at the rear end. The concentrated liquid B may have a pH of 6 to 9.

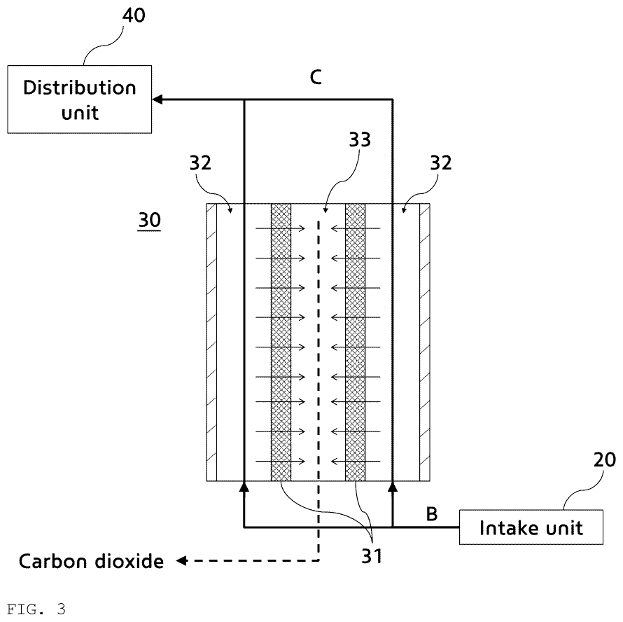

FIG. 3 illustrates a degassing unit 30 according to an example embodiment of the present disclosure. In embodiments, the degassing unit 30 may include a degassing separation membrane 31 installed therein. In embodiments, the degassing separation membrane 31 may divide an internal space of the degassing unit 30 into a concentrated liquid flow space 32 and a carbon dioxide degassing space 33.

In embodiments, the degassing separation membrane 31 may include a hollow fiber made of a polyolefin material such as, for example, polypropylene. In embodiments, the surface of the degassing membrane 31 includes micropores, so that the concentrated liquid B may not pass through the degassing membrane 31, but allows for carbon dioxide discharged from the concentrated liquid B to pass through the degassing membrane 31.

In embodiments, the degassing unit 30 may degas the carbon dioxide dissolved in the concentrated liquid B and supply the carbon dioxide to the carbon dioxide degassing space 33. More specifically, in embodiments, the concentrated liquid B is supplied to the concentrated liquid flow space 32, and the gases inside the carbon dioxide degassing space 33 are discharged to the outside so that the carbon dioxide dissolved in the concentrated liquid B may be degassed. To cause this to occur, the pressure within the degassing unit 30 is adjusted. Thereby, the concentrated liquid B may be separated into the carbon dioxide-degassed discharge liquid C and carbon dioxide.

In embodiments, the pressure within the degassing unit 30 may be normal pressure or vacuum but is not limited thereto as long as the pressure is a pressure at which carbon dioxide in the concentrated liquid B may be degassed.

In embodiments, the carbon dioxide discharged from the degassing unit 30 may have a purity of about 80 volume % or more, for example, about 90 volume % or more, about 95 volume % or more, or about 99.9 volume % or more.

In embodiments, the discharge liquid C may include one or more of an aqueous sodium bicarbonate (NaHCO₃) solution produced through a reaction of the first electrolyte solution A and carbon dioxide, potassium bicarbonate (KHCO₃), and combinations thereof. That is, the discharge liquid C may be a first electrolyte solution in which the remaining amount of carbon dioxide (i.e., that was not degassed) is dissolved. Carbon dioxide dissolved in the discharge liquid C may be solidified and collected in the first reaction unit 50, as described herein.

In embodiments, the discharge liquid C may have a pH of about 7 to 9.

In embodiments, the distribution unit 40 may be used to distribute the discharge liquid C to the first reaction unit 50 and the second reaction unit 60. The ratio of the discharge liquid C distributed from the distribution unit 40 is not particularly limited. In embodiments, the ratio may be appropriately adjusted depending on the molar ratio of the raw materials required in the first reaction unit 50 and the second reaction unit 60.

In embodiments, the first reaction unit 50 may receive a portion C1 of the discharge liquid from the distribution unit 40 and precipitate and recover carbon dioxide dissolved in the portion C1 of the discharge liquid. In some specific embodiments, the portion C1 of the discharge liquid may react with hydroxide to precipitate and recover the carbon dioxide in the form of carbonate.

In embodiments, the hydroxide may include a hydroxide of one or more metal ions such as, for example, calcium (Ca), magnesium (Mg), strontium (Sr), copper (Cu), lithium (Li), barium (Ba), iron (Fe), and combinations thereof. In embodiments, the hydroxide may preferably include a hydroxide of calcium. Hereinafter, for purposes of reference in the description of the present disclosure, the hydroxide will be described as containing calcium hydroxide (Ca(OH)₂), but the scope of the hydroxide is not limited thereto.

The portion of the discharge liquid C1 may react with the hydroxide as shown in Reaction Formula 2 below, and a carbonate and an aqueous alkaline solution D may be produced. In Reaction Formula 2 below, it is assumed for illustrative purposes that the discharge liquid is potassium bicarbonate (KHCO₃), and the hydroxide is calcium hydroxide.

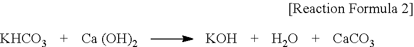

In embodiments, the carbonate may include a carbonate of one or more metal ions such as, for example, calcium (Ca), magnesium (Mg), strontium (Sr), copper (Cu), lithium (Li), barium (Ba), iron (Fe), and combinations thereof.

In embodiments, the first reaction unit 50 may further include a filter unit (not shown) that separates and recovers the carbonate.

In embodiments, the aqueous alkaline solution D may include one or more of an aqueous sodium hydroxide (NaOH) solution, an aqueous potassium hydroxide (KOH) solution, and combinations thereof.

In embodiments, the operating temperature of the first reaction unit 50 is not particularly limited and may be operated at room temperature (20° C.±5° C.) or at a temperature of 80° C. or lower using a temperature control device.

In embodiments, the molar ratio of the portion C1 of the discharge liquid and the hydroxide, which react with each other in the first reaction unit 50 may be in a range of about 1:0.5 to 1:2. When the molar ratio falls within the numerical range, the reaction of both components may sufficiently occur.

In embodiments, the aqueous alkaline solution D may have a pH of about 12 to 14.

In embodiments, in then the carbon dioxide capture system according to the present disclosure, the pH of the discharge liquid C is too low to be used as an electrolyte, and the aqueous alkaline solution D has a high pH. Therefore, the remaining portion C2 of the discharge liquid reacts with the aqueous alkaline solution D in the second reaction unit 60 to turn the resulting solution into a second electrolyte solution E of appropriate pH. The present disclosure has an established system capable of continuously capturing carbon dioxide by supplying the second electrolyte solution E to the electrolyte storage unit 10.

In embodiments, in the second reaction unit 60, the remaining portion C2 of the discharge liquid and the aqueous alkaline solution D may react as shown in Reaction Formula 3 below to produce a second electrolyte solution E. In Reaction Formula 3 below, it is assumed, for purposes of illustration, that the remaining portion C2 of the discharge liquid is potassium bicarbonate, and the aqueous alkaline solution D is potassium hydroxide. However, as described herein, the scope of the remaining portion of the discharge liquid C2 and the aqueous alkaline solution D is not limited thereto.

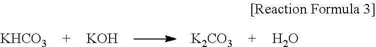

According to Reaction Formula 3, the second electrolyte solution E may include the same aqueous alkaline carbonate solution as the first electrolyte solution A.

The operating temperature of the second reaction unit 60 is not particularly limited and, in some embodiments, may be operated at room temperature (20° C.±5° C.) or a temperature of 80° C. or lower using a temperature control device.

In embodiments, the molar ratio of the remaining portion C2 of the discharge liquid and the aqueous alkaline solution D, which react with each other in the second reaction unit 60 may be in a range of about 1:0.5 to 1:1.2, or about 1:0.9 to 1:1.1. When the molar ratio falls within the range, the pH of the second electrolyte solution E may be adjusted to be the same or similar to the pH of the first electrolyte solution A.

In embodiments, the second electrolyte solution E may have a pH of about 9 to 12.5 or about 11 to 12.

According to the present disclosure, an aqueous alkaline carbonate solution is used as the first electrolyte solution A. The carbon dioxide included in the gas mixture may be captured with high efficiency by using the intake unit and the degassing unit including a membrane, respectively.

Meanwhile, the present disclosure may maximize the carbon dioxide capture rate by once again collecting the remaining carbon dioxide, which has not been degassed through the degassing unit, through the first reaction unit 50.

In addition, the present disclosure allows the system to operate continuously by recovering the second electrolyte solution through the second reaction unit 60 and then recirculating the second electrolyte solution.

Other embodiments and forms of the present disclosure will be described in more detail through examples below. The following examples are merely provided in an effort to aid understanding of the present disclosure, and the scope of the present disclosure is not limited thereto.

### Example 1, Comparative Example 1 and Comparative Example 2

An intake unit and a degassing unit according to FIGS. 2 and 3 were constructed. As intake and degassing separation membranes, those containing a hollow fiber made of polypropylene were used.

The first electrolyte solution according to Example 1 contained 0.1 M K₂CO₃ and had a pH of about 11.61. The first electrolyte solution according to Comparative Example 1 was water and had a pH of about 7. The first electrolyte solution according to Comparative Example 2 contained 2 M K₂CO₃ and had a pH of about 8.6.

A gas mixture supplied to the intake unit included carbon dioxide and nitrogen at a flow rate of 1:3. Specifically, carbon dioxide was supplied to the intake unit at a flow rate of 3.75 L/min, and nitrogen was supplied at a flow rate of 11.25 L/min. A pressure in the intake unit was adjusted to about 6 bar.

Approximately 50 L of the first electrolyte solution was supplied to the intake unit at a flow rate of approximately 5 L/min, and carbon dioxide was dissolved in the first electrolyte solution, thereby a concentrated liquid and residual gases discharged from the intake unit were obtained. The concentrated liquid was supplied to the degassing unit to degas the carbon dioxide, and the carbon dioxide and discharge liquid discharged from the degassing unit were collected.

The contents of carbon dioxide and nitrogen in the residual gases discharged from the intake unit were measured, and the composition of carbon dioxide discharged from the degassing unit was measured. On the basis of the results, the carbon dioxide absorption rate was calculated and shown in Table 1.

TABLE 1

| | | | | Carbon |
|---|---|---|---|---|
| | First | pH of First | pH of | Dioxide |
| | Electrolyte | Electrolyte | Discharge | Absorption |
| Division | Solution | Solution | Liquid | Rate [%] |
| Comparative | Water | 7 | 4.65 | 94.42 |
| Example 1 | | | | |
| Comparative | 2M KHCO₃ | 8.6 | 8.23 | 83.94 |
| Example 2 | | | | |
| Example 1 | 0.1M K₂CO₃ | 11.61 | 8.12 | 99.9 |

Referring to Table 1, it was found that Example 1, which used the first electrolyte solution with a pH of 9 to 12.5, had a high absorption rate of carbon dioxide included in the gas mixture and was able to recover high-purity carbon dioxide from the degassing unit compared to Comparative Example 1 and Comparative Example 2.

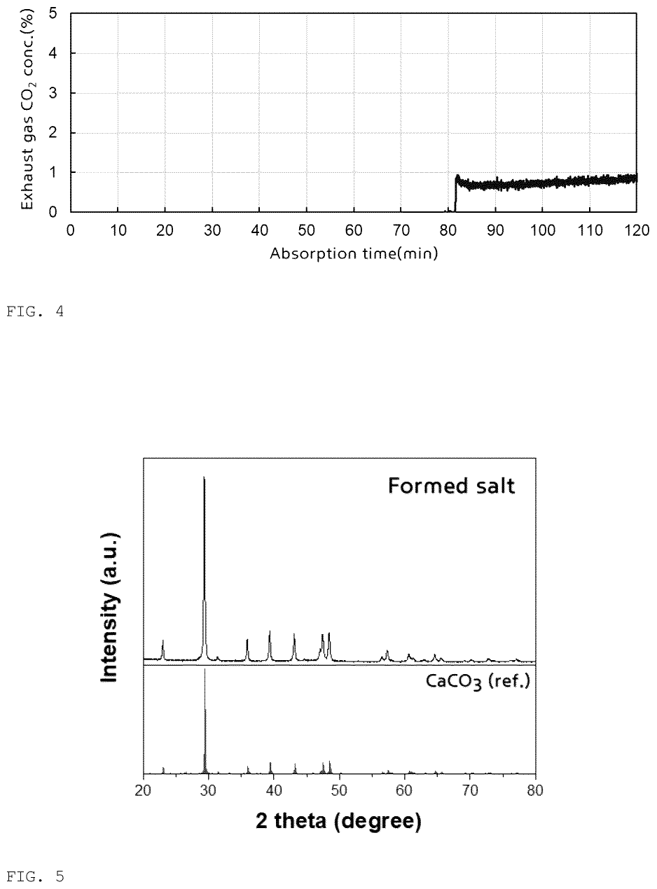

FIG. 4 shows a graph of the concentration of carbon dioxide emitted from the carbon dioxide capture system according to Example 1. Specifically, after a process of dissolving carbon dioxide in the first electrolyte solution in the intake unit was performed, the concentration of carbon dioxide in the residual gases discharged from the intake unit was measured. It was found that an initial dissolution rate of carbon dioxide was 99.99% and lasted for about 80 minutes.

### Example 2

The discharge liquid obtained in Example 1 reacted with calcium hydroxide at a molar ratio of 1:1. Specifically, calcium hydroxide powder was added to the discharge liquid and allowed to react for about 5 minutes at room temperature (20° C.±5° C.). The reaction is the same as Reaction Formula 2 described above and shown below.

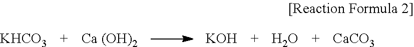

After the reaction, the aqueous alkaline solution had a pH of about 13.28, and the precipitate was recovered and subjected to X-ray diffraction analysis. The results are as shown in FIG. 5. Referring to FIG. 5, it was found that the precipitate is calcium carbonate (CaCO₃).

According to the present disclosure, carbon dioxide remaining in the discharge liquid could also be captured in the form of carbonate.

### Examples 3 to 7, Comparative Example 3, and Comparative Example 4

A second electrolyte solution was prepared by reacting the discharge liquid obtained in Example 1 with the aqueous alkaline solution obtained in Example 2 at the molar ratio shown in Table 2 below. The discharge liquid contained potassium bicarbonate (KHCO₃). The aqueous alkaline solution contained potassium hydroxide (KOH). The second electrolyte solution contained potassium carbonate (K₂CO₃).

The pH of each second electrolyte solution was measured.

TABLE 2

| | KHCO₃:KOH | pH of Second |
|---|---|---|
| Division | Molar Ratio | Electrolyte Solution |
| Comparative Example 3 | 1:2 | 12.81 |
| Comparative Example 4 | 1:1.5 | 12.61 |
| Example 3 | 1:1.2 | 12.32 |
| Example 4 | 1:1.1 | 12.00 |
| Example 5 | 1:1 | 11.63 |
| Example 6 | 1:0.9 | 11.07 |
| Example 7 | 1:0.5 | 10.09 |

Referring to Table 2, when the molar ratio of the remaining portion of the discharge liquid and the aqueous alkaline solution which reacted with each other in the second reaction unit was in a range of 1:0.5 to 1:1.2, the pH of the second electrolyte solution was controlled at a similar level to the pH of the first electrolyte solution, from 9 to 12.5, so that the second electrolyte solution was able to be recirculated into an electrolyte solution of the carbon dioxide capture system. When the pH of the second electrolyte solution was high, salt precipitated on the intake separator membrane and/or the degassing separator membrane. As a result, the contact area of the materials decreased. Thereby, the dissolution rate could decrease and the separator could be damaged.

As the experimental examples and examples of the present disclosure have been described in detail above, the scope of the present disclosure is not limited to the above-described experimental examples and examples. Various modifications and improvements made by those skilled in the art using the basic concept of the present disclosure defined in the following patent claims are also included in the scope of the present disclosure.

What is claimed is:

1. A carbon dioxide capture system comprising:
an electrolyte storage unit configured to hold a first electrolyte solution containing an aqueous alkaline carbonate solution;
an intake unit in fluid communication with the electrolyte storage unit and a gas supply, the intake unit configured to (i) receive the first electrolyte solution the electrolyte storage unit, (ii) receive a gas mixture comprising carbon dioxide from the gas supply, and (iii) prepare a concentrated liquid by dissolving the carbon dioxide in the gas mixture into the first electrolyte solution;
a degassing unit in fluid communication with the intake unit and with a discharge, the degassing unit configured to (i) degas carbon dioxide from the concentrated liquid supplied from the intake unit to provide a degassed concentrated liquid and (ii) discharge the carbon dioxide;
a distribution unit in fluid communication with the degassing unit and in fluid communication with at least one distribution line, the distribution unit configured to (i) receive the degassed concentrated liquid from the degassing unit and distributing the degassed concentrated liquid through the at least one distribution line;
a first reaction unit in fluid communication with the distribution unit and configured to react at least a portion of the degassed concentrated liquid from the distribution unit with a hydroxide under conditions to prepare a carbonate and an aqueous alkaline solution; and
a second reaction unit in fluid communication with (a) the electrolyte storage unit, (b) the distribution unit, and (c) the first reaction unit, and configured (i) to react the remaining portion of the degassed concentrated liquid from the distribution unit with an amount of the aqueous alkaline solution from the first reaction unit to prepare a second electrolyte solution and (ii) to supply the second electrolyte solution to the electrolyte storage unit.

2. The system of claim 1, wherein the aqueous alkaline carbonate solution comprises one or more of an aqueous sodium carbonate (Na₂CO₃) solution, an aqueous potassium carbonate (K₂CO₃) solution, and combinations thereof.

3. The system of claim 1, wherein the aqueous alkaline carbonate solution has a concentration of 0.0001 M to 0.5 M.

4. The system of claim 1, wherein the first electrolyte solution has a pH of 9 to 12.5.

5. The system of claim 1, wherein the intake unit comprises an intake separation membrane that divides its internal space into an electrolyte flow space and a gas mixture flow space, and
wherein the intake separation membrane is permeable to the carbon dioxide comprised in the gas mixture that flows in the gas mixture flow space, and allows the carbon dioxide to dissolve in the first electrolyte solution in the electrolyte flow space.

6. The system of claim 1, wherein the gas mixture comprises one or more selected of steelmaking by-product gas, exhaust gas, and combinations thereof.

7. The system of claim 1, wherein the gas mixture flow space has a pressure of 0.1 bar to 10 bar.

8. The system of claim 1, wherein the pressure of the gas mixture flow space is lower than the pressure of the electrolyte flow space,
wherein the pressure difference between the gas mixture flow space and the electrolyte flow space is in a range of 3 bar or less.

9. The system of claim 1, wherein the ratio of a flow rate of the gas mixture to a flow rate of the first electrolyte solution supplied to the intake unit is in a range of 0.1 to 15.

10. The system of claim 1, wherein the concentrated liquid has a pH of 6 to 9.

11. The system of claim 1, wherein the degassing unit comprises a degassing separation membrane that divides its internal space into a concentrated liquid flow space and a carbon dioxide flow space, and
wherein the degassing separation membrane is permeable to the carbon dioxide contained in the concentrated liquid flowing in the concentrated liquid flow space and allows the carbon dioxide to pass through the degassing separation membrane for discharge into the carbon dioxide flow space.

12. The system of claim 1, wherein the discharge liquid comprises one or more of an aqueous sodium bicarbonate (NaHCO₃) solution, an aqueous potassium bicarbonate (KHCO₃) solution, and combinations thereof.

13. The system of claim 1, wherein the discharge liquid has a pH of 7 to 9.

14. The system of claim 1, wherein the hydroxide comprises a hydroxide of one or more metal ions of calcium (Ca), magnesium (Mg), strontium (Sr), copper (Cu), lithium (Li), barium (Ba), iron (Fe), and combinations thereof.

15. The system of claim 1, wherein a molar ratio of the portion of the discharge liquid and the hydroxide, which react with each other in the first reaction unit, is in a range of 1:0.5 to 1:2.

16. The system of claim 1, wherein the carbonate comprises a carbonate of one or more metal ions of calcium (Ca), magnesium (Mg), strontium (Sr), copper (Cu), lithium (Li), barium (Ba), iron (Fe), and combinations thereof, and
the first reaction unit further comprises a filter unit configured to separate and recover the carbonate.

17. The system of claim 1, wherein the aqueous alkaline solution comprises one or more of an aqueous sodium hydroxide (NaOH) solution, an aqueous potassium hydroxide (KOH) solution, and combinations thereof.

18. The system of claim 1, wherein the aqueous alkaline solution has a pH of 12 to 14.

19. The system of claim 1, wherein a molar ratio of the remaining portion of the discharge liquid and the aqueous alkaline solution, which react with each other in the second reaction unit, is in a range of 1:0.5 to 1:1.2.

20. The system of claim 1, wherein the second electrolyte solution discharged from the second reaction unit has a pH of 9 to 12.5.
